(19) United States
(12) Patent Application Publication
(10) Pub. No.: US 2014/0165012 A1
(43) Pub. Date: Jun. 12, 2014

(54) SINGLE - GESTURE DEVICE UNLOCK AND APPLICATION LAUNCH

(71) Applicants: Wenbo Shen, Beijing (CN); Chunxiao Lin, Beijing (CN); Doug Dallman, Portland, OR (US)

(72) Inventors: Wenbo Shen, Beijing (CN); Chunxiao Lin, Beijing (CN); Doug Dallman, Portland, OR (US)

(21) Appl. No.: 13/997,824

(22) PCT Filed: Dec. 12, 2012
(86) PCT No.: PCT/CN2012/086396

§ 371 Date: Dec. 20, 2013

(51) Int. Cl. G06F 3/01

(52) U.S. Cl. CPC G06F 3/017
USPC 715/863

(57) ABSTRACT

A computing device can be unlocked and an application selected for execution with a single gesture. The single gesture can comprise a portion of an unlock gesture and an application selection gesture. An unlock-and-launch user interface can comprise a plurality of tracks and a user can unlock a device and select an application by first moving an icon in a first direction along a first track from a starting position and then along a second track in a second direction. A user can unlock a device and launch an application by supplying an unlock gesture and then selecting an application icon from a series of icons presented while the user's finger or stylus remains in contact with the touchscreen. Applications to be included in an unlock-and-launch interface can be selected by the user, or automatically selected by the device based on application usage and/or device context.

### BACKGROUND

Some modern computing devices can be unlocked with a touch gesture supplied by a user to a touchscreen. Once a device is unlocked, a user can launch an application by selecting an application via the touchscreen.

### BRIEF DESCRIPTION OF THE DRAWINGS

FIGS. 1A-1C illustrate exemplary user interfaces that can be displayed at a computing device touchscreen for unlocking the device and selecting an application for execution with a single gesture.

FIGS. 2A-2D illustrate a single gesture applied to a computing device touchscreen that unlocks the device and executes an application selected by the gesture.

FIGS. 3A-3D illustrate an exemplary sequence of user interfaces that can be presented at a computing device touchscreen to configure an unlock-and-launch interface.

FIGS. 4A-4C illustrate additional exemplary gestures that can be supplied to a computing device touchscreen to launch a specific application.

FIG. 5 is a block diagram of a first exemplary computing device in which technologies described herein can be implemented.

FIG. 6 is a flowchart of a first exemplary method of launching an application on a computing device.

FIG. 7 is a flowchart of a second exemplary method of launching an application on a computing device.

FIG. 8 is a block diagram of a second exemplary computing device in which technologies described herein can be implemented.

FIG. 9 is a block diagram of an exemplary processor core that can execute instructions as part of implementing technologies described herein.

### DETAILED DESCRIPTION

Technologies are described herein that provide for the unlocking of a computing device and the launching of a particular application with a single gesture applied to a touchscreen. The single gesture can comprise a portion of an unlock gesture and an application selection gesture. For example, a user can unlock a device and launch a desired application by first sliding an icon from a starting location along a first track (a portion of an unlock gesture) and then sliding the icon toward an application icon located near the end of a second track (an application selection gesture). By being able to unlock a computing device and launch a specific application with a single gesture, a user is spared from having to apply multiple gestures to achieve the same result.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to cover all modifications, equivalents, and alternatives within the scope of the claims.

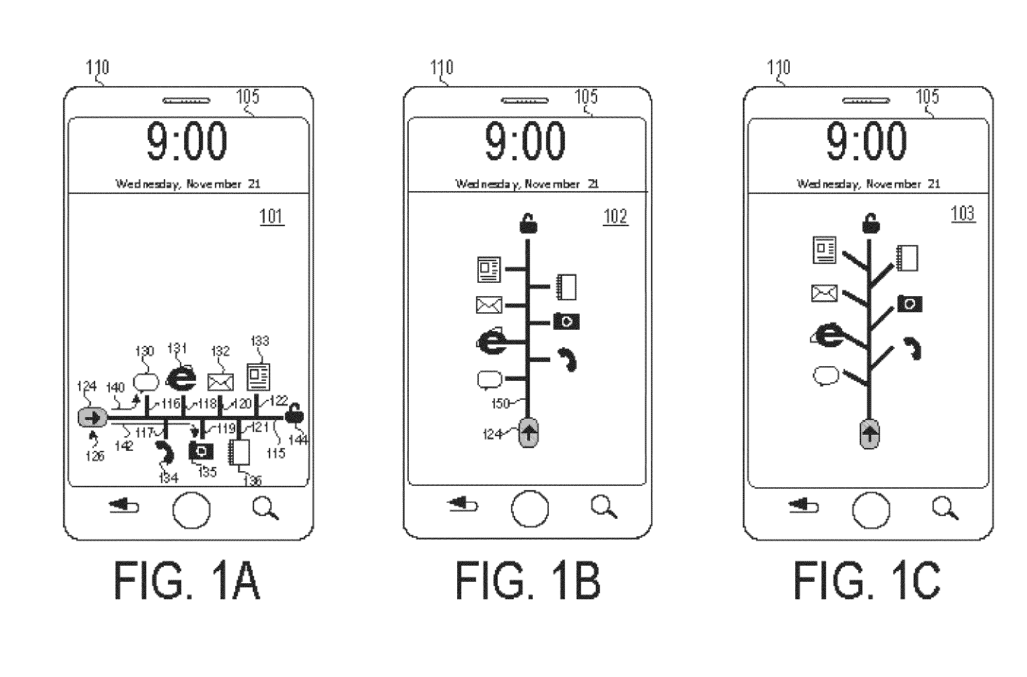

FIGS. 1A-1C illustrate exemplary user interfaces 101-103 that can be displayed at a touchscreen 105 of a computing device 110 for unlocking the device 110 and selecting an application for execution with a single gesture. As used herein, the term “unlock-and-launch user interface” refers to any user interface or sequence of user interfaces that allow a user to unlock a computing device and select an application for execution with a single gesture. A single gesture refers to one or more movements made by a touching object, such as a user's finger or stylus, while in continuous contact with a touchscreen. Thus, a single gesture can comprise a user making a first trace with a touching object on a touchscreen, pausing while keeping the touching object in contact with the touchscreen, and then making a second trace on the touchscreen. A locked device refers to any device in which access to device features and applications available in an unlocked mode have been restricted. In general, unlocking a computing device requires a user to provide a specified input to the device, such as a specific password or gesture.

In FIG. 1A, the user interface 101 comprises a plurality of tracks 115-122, a main track 115 connected to spurs 116-122, along which an icon 124 starting at a starting location 126 can be moved. Applications can be associated with the spurs 116-122 (or ends of the spurs). Application icons 130-136 are located near the ends of the spurs 116-122. An application can be software separate from the computing device's operating system, such as a word processing, spreadsheet, gaming or social media application; or software that is a component or feature of an operating system, such as a phone, contact book or messaging application. Further, an application can be a short cut to a file, such as a web page bookmark, audio file, video file or word processing document, where selection of the short cut causes the application associated with the file to be launched and the file to be loaded into (played, etc.) the application. For example, selecting a web page bookmark icon will cause the associated web browser to be launched and the selected web page to be loaded, selecting a video icon will cause a video player to be launched and the selected video to be played, and selecting a settings icon will cause the device to navigate to a settings menu. The application icons 130-136 comprise a messaging icon 130, web browser icon 131, email icon 132, newspaper web page bookmark icon 133, phone icon 134, camera icon 135 and contact book icon 136. An unlock icon 144 is located near an end of the main track 115.

A user can unlock the computing device 110 and launch a particular application by applying a single gesture to the touchscreen 105. The single gesture can comprise a portion of an unlock gesture and an application selection gesture. Applying the unlock gesture to the touchscreen 105 can unlock the device 110 without launching a user-selected application. In the user interface 101, the unlock gesture comprises sliding the icon 124 from the starting point 126 to the opposite end of the main track 115, toward the unlock icon 144. Thus, a portion of the unlock gesture comprises moving the icon 124 toward, but not all of the way to, the end of the main track 115. In the user interface 101, the application selection gesture comprises a user sliding the icon 124 along one of the spurs 116-122 from the point where the spur connects to the main track 115 to the end of the spur.

Accordingly, to unlock the computing device 110 and launch a messaging application with a single gesture, a user can first move the icon 124 horizontally from the starting position 126 to the point where the main track 115 and the spur 116 meet (a portion of the unlock gesture) and then upwards vertically along spur 116 to the end of spur 116 (an application selection gesture), as indicated by path 140. To unlock the device 110 and launch a camera application associated with the camera application icon 134, the user can first move the icon 124 horizontally from the starting position 126 to the point where the main track 115 meets the spur 119, and then downwards vertically to the end of the track 119, indicated by path 142.

FIGS. 1B and 1C illustrate additional user interfaces 102 and 103 comprising main track-and-spur configurations for unlocking the computing device 110 and launching an application with a single gesture. In FIG. 1B, a main track 150 is oriented vertically and the spurs are oriented horizontally. Thus, a user first moves the icon 124 vertically along the main track 150 and then horizontally along one of the spurs to select an application to be launched. In FIG. 1C, the main track is oriented vertically and the spurs are arranged in a non-orthogonal manner relative to the main track.

Other track and application icon arrangements in which an icon is moved in a first direction along a first track from a starting position and then in a second direction along a second track to unlock a device and select an application are possible. For example, it is not necessary that the tracks be straight lines. In some embodiments, one of more of the tracks can be curved. Moreover, it is not necessary that tracks have a main track-spur configuration. In various embodiments, application icons for any combination of applications that can be executed on the device 110 can be included in an unlock-and-launch user interface. Furthermore, it is not necessary that an unlock icon be displayed in the user interface. Moreover, some tracks in an unlock-and-launch interface may not be associated with an application. For example, a user may have removed an application from being associated with a track, or not yet assigned an application to a track.

In some embodiments, spur length, the distance between spurs and/or the distance from the starting location of the icon to the nearest spur, as well as additional unlock-and-launch user interface characteristics can be selected to reduce the likelihood that the icon could be unintentionally moved from the starting position to the end of one of one of the spurs. In some embodiments, the icon can automatically return to the starting position once the touching object (finger, stylus, etc.) that moved the icon away from the starting position is no longer in contact with the touchscreen.

In various embodiments, an unlock-and-launch user interface can include application indicators other than application icons to indicate the applications that can be launched from a locked device. Examples of other application indicators include thumbnails of application screenshots, application names, or track characteristics (e.g., track color, shape or length). For example, a yellow spur could be associated with an email application.

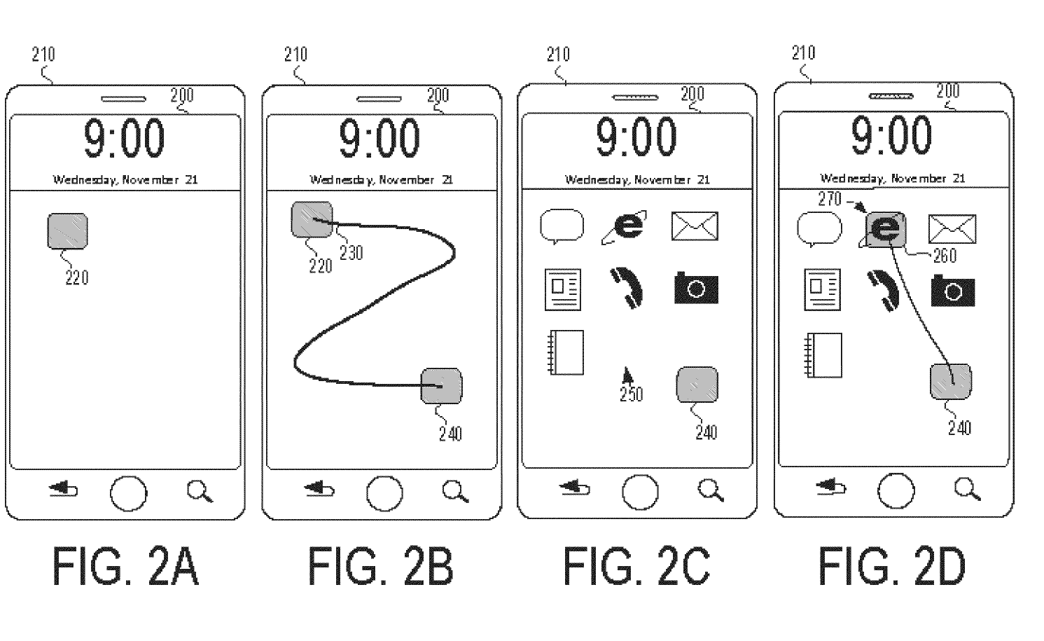

FIGS. 2A-2D illustrate a single gesture applied to a touchscreen 200 of a computing device 210 that unlocks the device and executes a selected application. In FIG. 2A, a touching object, such as a user's finger or stylus is detected by the computing device to be in contact with the touchscreen 200 at a start location 220. It is not necessary that a touching object be in physical contact with a touchscreen for the touching object to be deemed touching the touchscreen. Depending on the sensing technology utilized by the computing device, a computing device can detect the presence of a touching object near the touchscreen surface without the touching object actually touching the touchscreen surface.

In FIG. 2B, a user has supplied an unlock gesture 230 to the touchscreen. The touching object remains in contact with the touchscreen 200 at an ending location 240. The unlock gesture 230 can be any gesture, such as the “Z” gesture shown in FIG. 2B. For example, an unlock gesture can be sliding an icon along the length of a track, similar to the unlock gesture in FIG. 1A comprising the icon 124 being moved to the end of the main track 115 from the starting point 126, connecting dots in an array of dots presented at the touchscreen in a designated order, or any other gesture.

In FIG. 2C, in response to determining that the gesture 230 is an unlock gesture and that the touching object remains in contact with the touchscreen 200, a plurality of application icons 250 are presented at the touchscreen 200. In embodiments where user interface elements are presented as part of receiving an unlock gesture, such as an array of dots, those user interfaces can be removed after detection of an unlock gesture.

In FIG. 2D, the user supplies an application selection gesture by moving the touching object from the ending location 240 to a region 260 occupied by an application icon 270. To complete the single gesture, the user can lift the touching object from the touchscreen 200. In response, the computing device determines the application icon 270 to be the selected application icon, and executes an associated application. In alternative embodiments, an application can be launched when the touching object is first moved to a location where an application icon is displayed or when the touching object has settled on a region where an application icon is displayed for a specified amount of time (e.g., one-quarter, one-half or one second) and before the touching object is removed from the surface of the touchscreen 200.

The computing device 200 can detect an unlock gesture while the touching object is in contact with the touchscreen in various manners. For example, the computing device can determine whether user input comprises an unlock gesture after the touching object has been substantially stationary for a specified period of time, once the area occupied by the user input exceeds a specified area threshold, after a distance traced by the touching object on the touchscreen has exceeded a specified distance, or the touching object has changed direction more than a specified amount of times.

The application indicators presented at a touchscreen as part of an unlock-and-launch user interface can be configurable. In some embodiments, a user can select the application indicators to be displayed in an unlock-and-launch user interface and their arrangement.

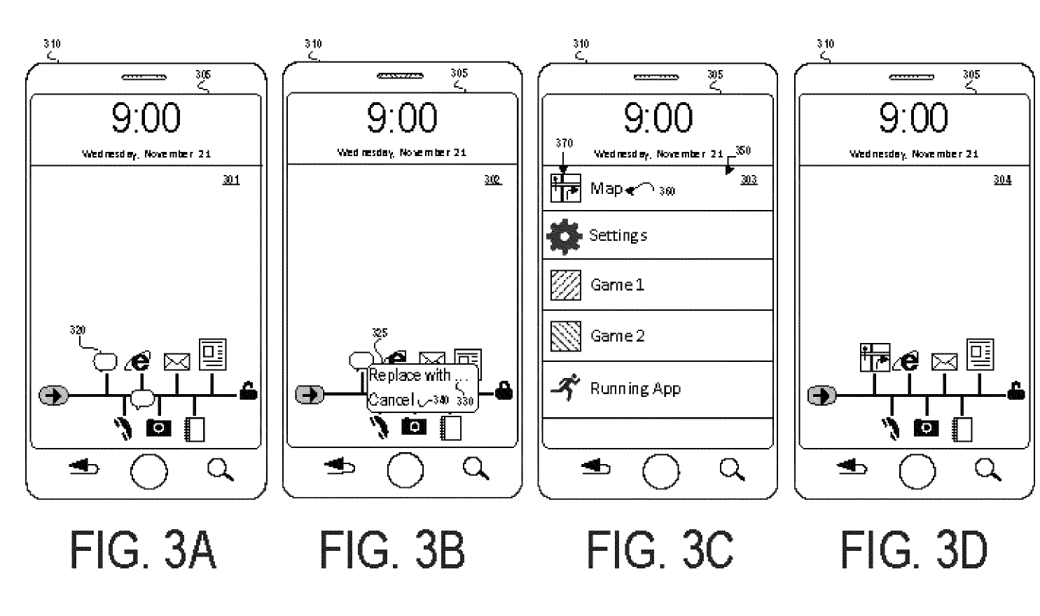

FIGS. 3A-3D illustrate an exemplary sequence of user interfaces 301-304 that can be presented at a touchscreen 305 of a computing device 310 to configure an unlock-and-launch interface. In FIG. 3A, user interface 301 comprises a main track-and-spur configuration. The user interface 301 comprises a messaging icon 320 that a user wishes to replace with an icon for a mapping application, an application that the user has been using more frequently than the messaging application of late. The user selects the messaging icon 320 to begin the configuration procedure. A user can select an application icon by, for example, supplying an input that the user would be unlikely to supply inadvertently, such as double-tapping the application icon or touching the application icon for at least a specified period.

FIG. 3B illustrates a user interface 302 that can be presented in response to a user selecting the messaging icon 320 for replacement. Selection of the messaging icon 320 causes a menu 325 to appear containing a replace option 330 (“Replace with . . . ”) to replace the selected icon and a cancel option 340 to cancel the configuration operation. The menu 325 can comprise additional options, such as “Delete” to delete the selected application icon, “Move” to swap the selected icon with another application icon, or “Configure Spur” to change characteristics of the spur associated with the selected application icon. A user may wish to change spur characteristics to, for example, make it more convenient for the user to select a particular application. Configurable spur characteristics include spur length and the orientation of a spur relative to another track.

FIG. 3C illustrates a user interface 303 that can be displayed in response to the user selecting the replace option 330. The user interface 303 comprises a list of applications 350 from which the user can select an application to replace the messaging application. The list 350 comprises application names and associated application icons, and includes a mapping application 360 having an associated mapping application icon 370. The list can be scrollable, allowing the user to select from a number of applications greater than the number of applications that can be displayed on the touchscreen at once.

FIG. 3D illustrates a user interface 304 that can be displayed after the user has selected the mapping application to replace the messaging application in the unlock-and-launch user interface. The user interface 304 comprises the mapping application icon 370 in the position previously occupied by the messaging icon 320.

The applications that can be launched from an unlock-and-launch user interface can be selected in other manners. For example, the user can navigate to a settings menu of the computing device that allows the user to select which applications are to be included in an unlock-and-launch user interface.

In some embodiments, the applications that can be launched from an unlock-and-launch user interface can be automatically selected by a computing device based on application usage, such as frequency or recency of use. For example, an unlock-and-launch user interface can comprise applications most frequently used over a default or configurable time period (e.g., day, week, month, year, operational lifetime of the device), applications that have been used at least a certain number of times within a recent time period, or the most recently used applications within a recent time period. In some embodiments, application icons associated with more frequently or recently used applications are positioned closer to the icon starting point than applications icons associated with less frequently or recently used applications.

In some embodiments, the applications that can be launched from an unlock-and-launch user interface can be selected based on an operating context of the computing device. For example, the applications included in an unlock-and-launch interface can depend on the time. For instance, during typical working hours (e.g., 8:00 AM-5:00 PM on weekdays), the applications included in an unlock-and-launch user interface can comprise work productivity applications, such as word processing and spreadsheet applications, and an email application with access to a work email account of the user. During typical non-working hours, such as weekends and weekday evenings, the applications that can be launched from an unlock-and-launch user interface can include recreational and leisure applications, such as gaming, social networking, personal finance or exercise applications.

Applications included in an unlock-and-launch interface can depend on device location as well, which can be determined by, for example, GPS, Wi-Fi positioning, cell tower triangulation or other methods. For example, work-related applications can be presented in an unlock-and-launch user interface when a device is determined to be located at a user's place of work, and non-work-related applications can be presented when the user is elsewhere. For example, an exercise application can be included if the user is at his or her gym; and gaming, media player or social network applications can be included when the user is at home.

In some embodiments, an unlock-and-launch user interface can comprise tracks associated with a user-specified application and tracks that are associated with an application depending on application usage and/or device context. For example, with reference to FIG. 1A, a user can have expressly assigned a messaging and web browser applications to spurs 116 and 117, and the applications associated with spurs 118 and 119 can be recently-used or frequently-used applications.

The applications to be included in an unlock-and-launch user interface based on device context can be user-selected or selected automatically by the computing device. For example, a user can set up various context profiles based on the time, device location and/or other factors. A context profile can indicate applications that can be presented for selection in an unlock-and-launch user interface if conditions in the context profile are satisfied. Alternatively, the computing device can monitor if a user frequently uses a particular application while at a specific location or during a specific time range, and include the application in an unlock-and-launch interface when the user is next at that location or the next time the user is using the device during that time.

In some embodiments, a computing device can be unlocked and a specific application launched with a single gesture based on the shape of the gesture. For example, a gesture comprising a letter, number or symbol traced on a touchscreen can cause the computing device to unlock and a particular application be launched. For instance, tracing the letter “W” on a touchscreen can unlock the device and launch a web browser, tracing the letter “E” can unlock the device and launch an email application, and tracing a “U” can cause the device to unlock without launching a specific application. The association between a gesture shape and an application can be set by default settings or be user-defined. In some embodiments, user-defined gestures (e.g., non-alphanumeric characters) can be associated with launching specific applications.

In various embodiments, the application associated with a particular gesture can be based on application usage. For example, tracing a “1” on a touchscreen can cause a most recently or frequently used application to be launched, tracing a “2” on the touchscreen can cause a second most recently or frequently used application to be launched, etc.

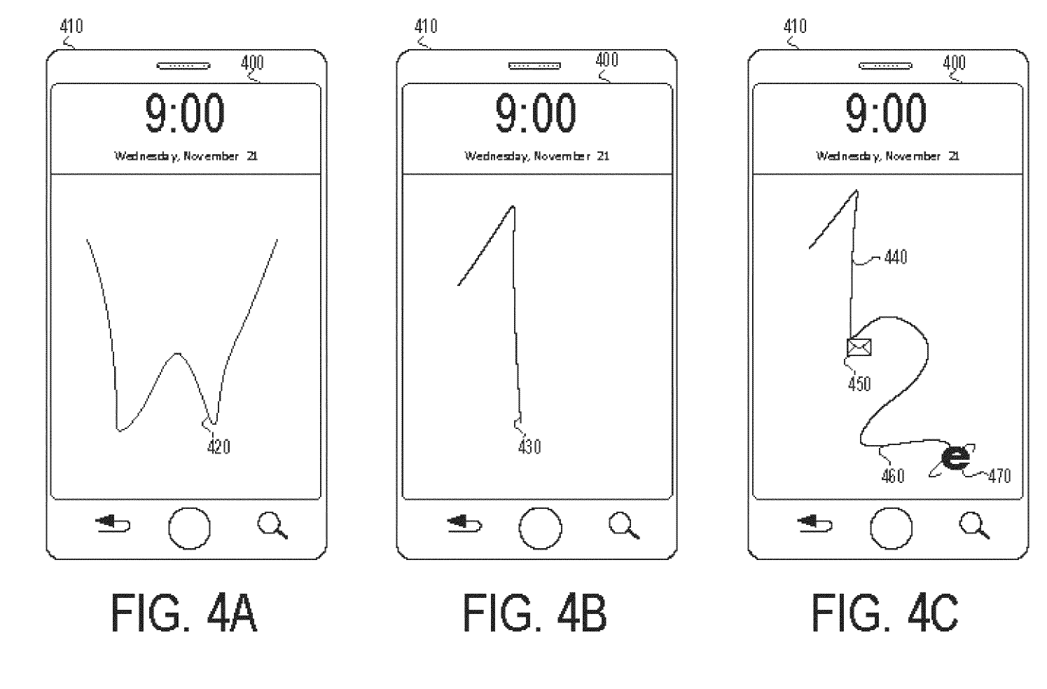

FIGS. 4A-4C illustrate additional exemplary gestures that can be supplied to a touchscreen 400 of a computing device 410 to launch a specific application. A “W” gesture 420 can unlock the device and cause a web browser application to launch and a “1” gesture 430 can unlock the device and cause a most frequently used application to be launched. Typically, the gestures are complex enough such that it is unlikely that the device would become unlocked and an application launched inadvertently. Thus, it is convenient for the gesture “1” to be more complex than a simple vertical line, such as the gesture 430 in FIG. 4B.

In some embodiments, where tracing a number launches an application based on application usage, the device can provide feedback to the user after the user has traced a number on the touchscreen to inform the user which application is associated with the traced number. This feedback can help the user avoid launching undesired applications. For example, consider the situation where a web browser is the most frequently used application and an email application is the second most-frequently used application. If the email application later becomes the most frequently used application and the web browser becomes the second most-frequently used application, the user may not be aware of this change. Thus, a user tracing a “1” on the touchscreen and expecting to launch a web browser may instead launch the email application.

FIG. 4C illustrates exemplary feedback that can be presented on the touchscreen 400 to indicate which application will be launched in response to the user tracing a number on the touchscreen to launch an application based on application usage. After drawing a “1” gesture 440, an email application 460 is presented to indicate that the email application is the most frequently used application. The application icon 460 can be presented while the gesture 440 is being drawn. For example, if the computing device 410 analyzes gesture input on the fly, the application icon 460 can be displayed as soon as the computing device 410 determines that the gesture being supplied is a “1” and before the user removes his finger or other touching object from the touchscreen 400. Removing the touching object from the touchscreen 400 unlocks the device 410 and launches the email application associated with the email application icon 450.

If the user intended to launch the device's web browser application, thinking that the web browser application was the most frequently used application, the user can supplying a second numeric gesture to the computing device 410, without removing the touching object from the touchscreen 400, to launch a different application. The device 410 can discard the previously supplied user input if, for example, the user keeps the touching object in contact with the touchscreen 400 for more than a specified amount of time, such as one-half second. Any subsequent user input provided at the touchscreen 400 can be analyzed as a new gesture. In FIG. 4C, after seeing the application icon 450 appear, the user pauses the touching object on the touchscreen and then draws a “2” gesture 460. In response, after detecting the “2” gesture, the device presents the web browser application icon 470, the icon associated with the web browser, the second most frequently used application. Removing the touching object after drawing the “2” gesture 460 results in the device 410 being unlocked and the web browser being launched. Although application icons 450 and 470 are presented as feedback in FIG. 4C, other application indicators could be presented, such as application names.

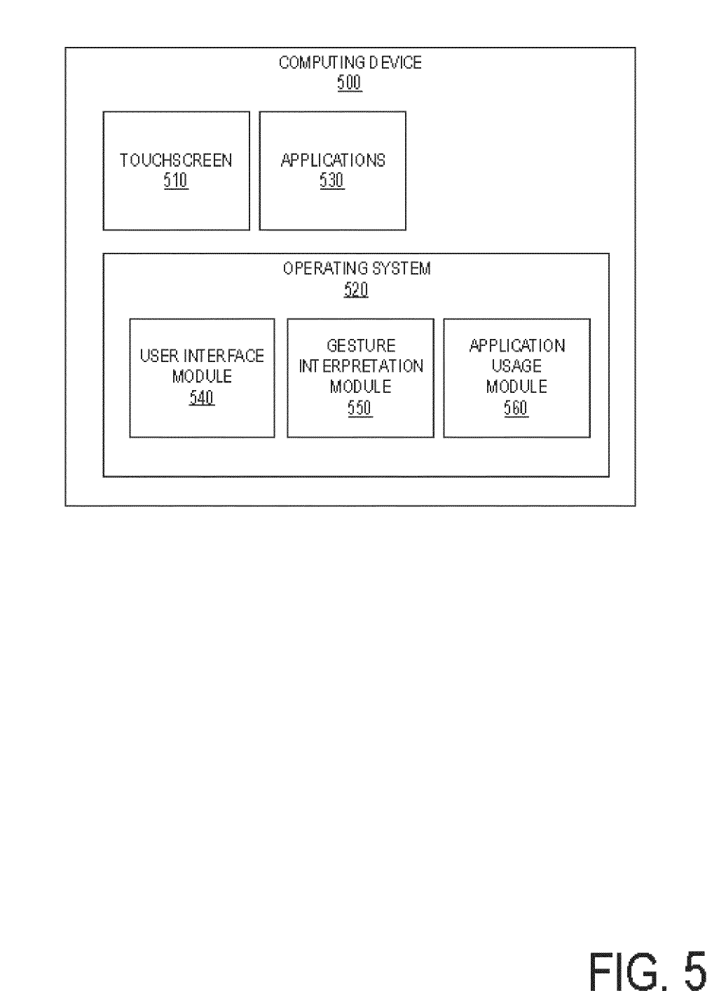

FIG. 5 is a block diagram of an exemplary computing device 500 in which technologies described herein can be implemented. The computing device 500 comprises a touchscreen 510, an operating system 520 and one or more applications 530 stored locally. The operating system 520 comprises a user interface module 540, a gesture interpretation module 550, and an application usage module 560. The user interface module 540 displays content and receives user input at the touchscreen 510. The gesture interpretation module 550 determines gestures from user input received at the touchscreen 510, including unlock gestures, portions of unlock gestures and application selection gestures. The application usage module 560 can determine how recently and frequently the applications 530 are used, and can determine the most recently or frequently used applications over a specified time. The operating system 520 can determine whether the computing device 500 is to be unlocked and which application, if any, is to be executed upon unlocking the computing device 500, in response to the gesture interpretation module 550 detecting a portion of an unlock gesture and an application selection gesture.

It is to be understood that FIG. 5 illustrates one example of a set of modules that can be included in a computing device. In other embodiments, a computing device can have more or fewer modules than those shown in FIG. 5. Moreover, any of the modules shown in FIG. 5 can be part of the operating system of the computing device 500, one or more software applications independent of the operating system, or operate at another software layer. Further, the modules shown in FIG. 5 can be implemented in software, hardware, firmware or combinations thereof. A computer device referred to as being programmed to perform a method can be programmed to perform the method via software, hardware, firmware or combinations thereof.

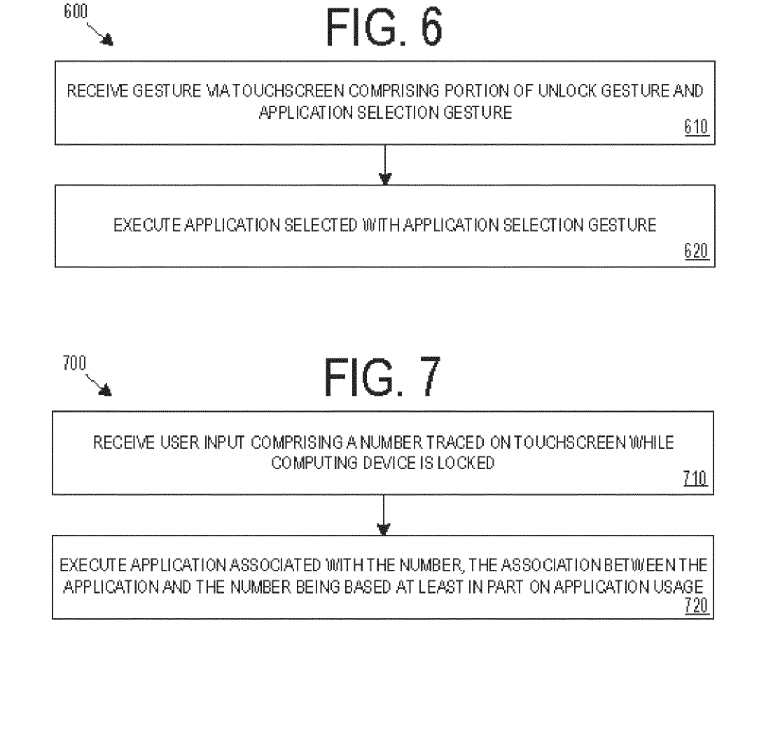

FIG. 6 illustrates a flowchart of a first exemplary method 600 of launching an application on a computing device. The method 600 can be performed by, for example, a locked smartphone. At process act 610, a gesture is received via a touchscreen of the computing device. The gesture comprises a portion of an unlock gesture and an application selection gesture. In the example, the smartphone presents the unlock-and-launch user interface 101 illustrated in FIG. 1A. The user, wishing to unlock the device and launch an email application installed on the phone, first slides the icon 124 left-to-right from the starting position 126 along the main track 115, and then upwards along the spur 120 to the email application icon 132. At process act 620, an application selected with the application selection gesture is executed. In the example, the smartphone executes the email application.

In some embodiments, the method 600 can include additional process acts. For example, consider a smartphone that has received an unlock gesture and the touching object that provided the unlock gesture is still in contact with the touchscreen. In such a situation, the method 600 can further comprise, in response to receiving the unlock gesture and while the touching object is still touching the touchscreen, presenting a plurality of application indicators at the touchscreen. For example, if a user applied an unlock gesture (e.g., the letter “Z” traced on the screen) to a smartphone with his or her finger, the smartphone can present a plurality of application icons at the touchscreen while the user's finger is still in contact with the touchscreen. The application selection gesture can comprise selecting one of the plurality of application indicators, the executed application being an application associated with the selected application indicators. In the example, the user selects a word processing application icon by dragging his or her finger to the region of the touchscreen occupied by the word processing application icon, and the device launches the corresponding word processing application.

FIG. 7 illustrates a flowchart of a second exemplary method 700 of launching an application on a computing device. The method 700 can be performed by, for example, a tablet computer. At process act 710, user input is received comprising a number traced on a touchscreen of the computing device while the computing device is locked. In the example, the user traces the number “1” on the tablet touchscreen. At process act 720, an application associated with the number is executed. The association between the executed application and the number is based at least in part on a usage of the application. In the example, the tablet computer executes a web browser application, which was the most frequently used application over the past week. In this example, the gesture “1” is associated with the most-frequently used application during the prior week.

One exemplary advantage of the technologies described herein is the ability of a user to unlock a computing device and select an application to be executed with a single gesture. This can relieve the user of having to make multiple gestures to unlock a device and launch an application, which can comprise the user having to scroll through multiple pages of applications to find the application the user desires to launch after the device has been unlocked. Additional advantages include the ability for the user to select the applications that can be launched from an unlock-and-launch user interface. Further, the single gesture typically comprises moving an icon in two different directions, making it less likely that a device is unlocked and an application launched inadvertently. Another advantage is that the technologies can incorporate known unlock gestures, thus making unlock-and-launch user interfaces more familiar to users. For example, the unlock gesture in the unlock-and-launch user interface 101 in FIG. 1A is a known slide-to-unlock gesture.

The technologies described herein can be performed by any of a variety of computing devices, including mobile devices (such as smartphones, handheld computers, tablet computers, laptop computers, media players, portable gaming consoles, cameras and video recorders), non-mobile devices (such as desktop computers, servers, stationary gaming consoles, smart televisions) and embedded devices (such as devices incorporated into a vehicle). The term “computing devices” includes computing systems and includes devices and systems comprising multiple discrete physical components.

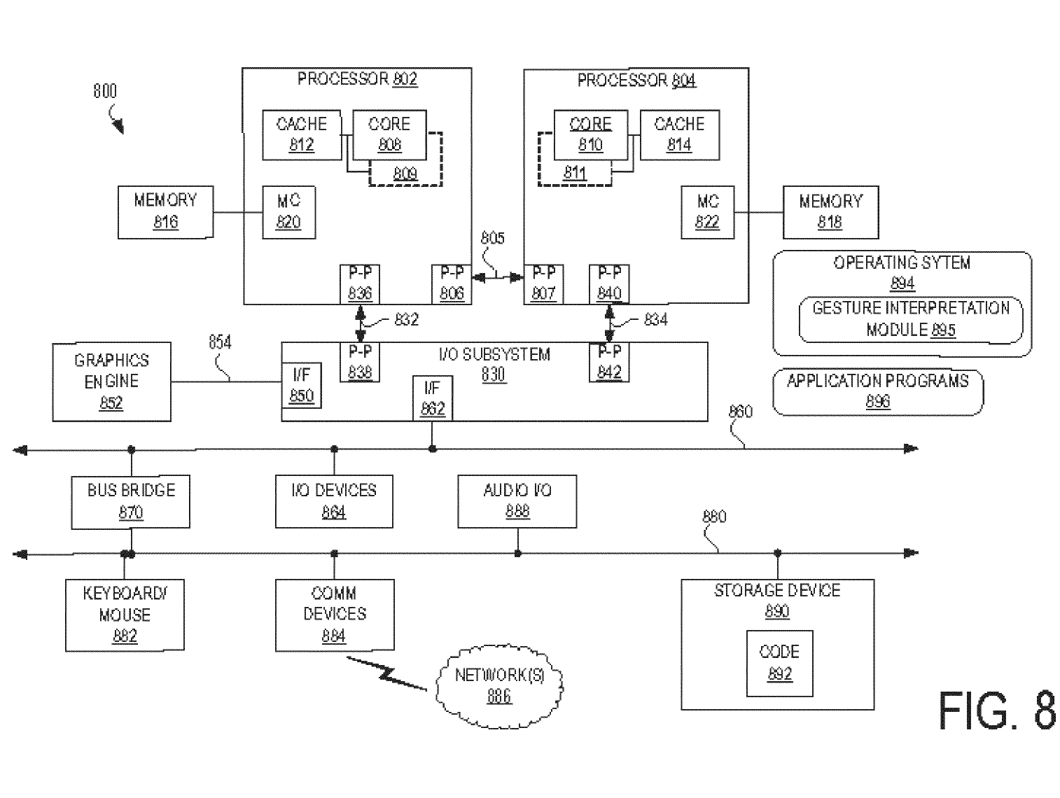

FIG. 8 is a block diagram of a second exemplary computing device 800 in which technologies described herein can be implemented. Generally, components shown in FIG. 8 can communicate with other components, although not all connections are shown, for ease of illustration. The device 800 is a multiprocessor system comprising a first processor 802 and a second processor 804 and is illustrated as comprising point-to-point (P-P) interconnects. For example, a point-to-point (P-P) interface 806 of the processor 802 is coupled to a point-to-point interface 807 of the processor 804 via a point-to-point interconnection 805. It is to be understood that any or all of the point-to-point interconnects illustrated in FIG. 8 can be alternatively implemented as a multi-drop bus, and that any or all buses illustrated in FIG. 8 could be replaced by point-to-point interconnects.

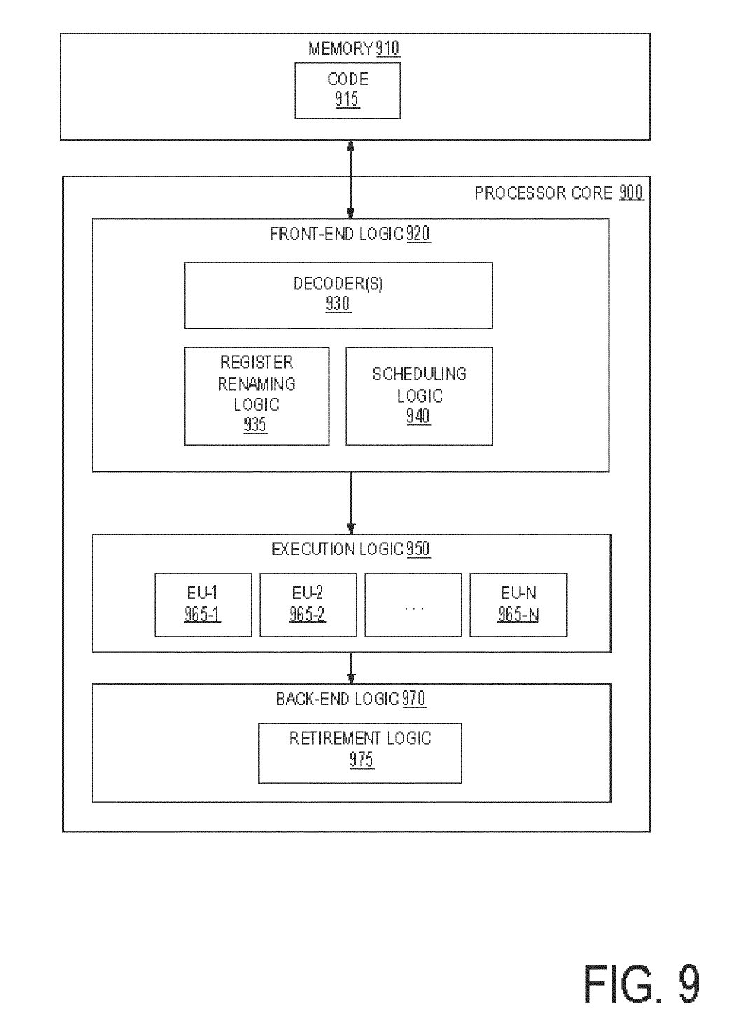

As shown in FIG. 8, the processors 802 and 804 are multicore processors. Processor 802 comprises processor cores 808 and 809, and processor 804 comprises processor cores 810 and 811. Processor cores 808-811 can execute computer-executable instructions in a manner similar to that discussed below in connection with FIG. 9, or in other manners.

Processors 802 and 804 further comprise at least one shared cache memory 812 and 814, respectively. The shared caches 812 and 814 can store data (e.g., instructions) utilized by one or more components of the processor, such as the processor cores 808-809 and 810-811. The shared caches 812 and 814 can be part of a memory hierarchy for the device 800. For example, the shared cache 812 can locally store data that is also stored in a memory 816 to allow for faster access to the data by components of the processor 802. In some embodiments, the shared caches 812 and 814 can comprise multiple cache layers, such as level 1 (L1), level 2 (L2), level 3 (L3), level 4 (L4), and/or other caches or cache layers, such as a last level cache (LLC).

Although the device 800 is shown with two processors, the device 800 can comprise one processor or more than two processors. Further, a processor can comprise one or more processor cores. A processor can take various forms such as a central processing unit, a controller, a graphics processor, an accelerator (such as a graphics accelerator or digital signal processor (DSP)) or a field programmable gate array (FPGA). A processor in a device can be the same as or different from other processors in the device. In some embodiments, the device 800 can comprise one or more processors that are heterogeneous or asymmetric to a first processor, accelerator. FPGA, or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 802 and 804 reside in the same die package.

Processors 802 and 804 further comprise memory controller logic (MC) 820 and 822. As shown in FIG. 8, MCs 820 and 822 control memories 816 and 818 coupled to the processors 802 and 804, respectively. The memories 816 and 818 can comprise various types of memories, such as volatile memory (e.g., dynamic random access memories (DRAM), static random access memory (SRAM)) or non-volatile memory (e.g., flash memory). While MCs 820 and 822 are illustrated as being integrated into the processors 802 and 804, in alternative embodiments, the MCs can be logic external to a processor, and can comprise one or more layers of a memory hierarchy.

Processors 802 and 804 are coupled to an Input/Output (J/O) subsystem 830 via P-P interconnections 832 and 834. The point-to-point interconnection 832 connects a point-to-point interface 836 of the processor 802 with a point-to-point interface 838 of the I/O subsystem 830, and the point-to-point interconnection 834 connects a point-to-point interface 840 of the processor 804 with a point-to-point interface 842 of the I/O subsystem 830. Input/Output subsystem 830 further includes an interface 850 to couple I/O subsystem 830 to a graphics engine 852, which can be a high-performance graphics engine. The I/O subsystem 830 and the graphics engine 852 are coupled via a bus 854. Alternately, the bus 844 could be a point-to-point interconnection.

Input/Output subsystem 830 is further coupled to a first bus 860 via an interface 862. The first bus 860 can be a Peripheral Component Interconnect (PCI) bus, a PCI Express bus, another third generation I/O interconnection bus or any other type of bus.

Various I/O devices 864 can be coupled to the first bus 860. A bus bridge 870 can couple the first bus 860 to a second bus 880. In some embodiments, the second bus 880 can be a low pin count (LPC) bus. Various devices can be coupled to the second bus 880 including, for example, a keyboard/mouse 882, audio I/O devices 888 and a storage device 890, such as a hard disk drive, solid-state drive or other storage device for storing computer-executable instructions (code) 892. The code 892 comprises computer-executable instructions for performing technologies described herein. Additional components that can be coupled to the second bus 880 include communication device(s) 884, which can provide for communication between the device 800 and one or more wired or wireless networks 886 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

The device 800 can comprise removable memory such flash memory cards (e.g., SD (Secure Digital) cards), memory sticks, Subscriber Identity Module (SIM) cards). The memory in device 800 (including caches 812 and 814, memories 816 and 818 and storage device 890) can store data and/or computer-executable instructions for executing an operating system 894 and application programs 896. Example data includes web pages, text messages, images, sound files, video data, biometric thresholds for particular users or other data sets to be sent to and/or received from one or more network servers or other devices by the device 800 via one or more wired or wireless networks, or for use by the device 800. The device 800 can also have access to external memory (not shown) such as external hard drives or cloud-based storage.

The operating system 894 can control the allocation and usage of the components illustrated in FIG. 8 and support one or more application programs 896. The operating system 894 can comprise a gesture interpretation module 895 that detects all or a portion of an unlock gesture and application selection gestures. The application programs 896 can include common mobile computing device applications (e.g., email applications, calendars, contact managers, web browsers, messaging applications) as well as other computing applications.

The device 800 can support various input devices, such as a touchscreen, microphone, camera, physical keyboard, proximity sensor and trackball, and one or more output devices, such as a speaker and a display. Other possible input and output devices include piezoelectric and other haptic I/O devices. Any of the input or output devices can be internal to, external to or removably attachable with the device 800. External input and output devices can communicate with the device 800 via wired or wireless connections.

In addition, the computing device 800 can provide one or more natural user interfaces (NUIs). For example, the operating system 892 or applications 894 can comprise speech recognition logic as part of a voice user interface that allows a user to operate the device 800 via voice commands. Further, the device 800 can comprise input devices and logic that allows a user to interact with the device 800 via a body, hand or face gestures. For example, a user's hand gestures can be detected and interpreted to provide input to a gaming application.

The device 800 can further comprise one or more wireless modems (which could comprise communication devices 884) coupled to one or more antennas to support communication between the system 800 and external devices. The wireless modems can support various wireless communication protocols and technologies such as Near Field Communication (NFC), Wi-Fi, Bluetooth, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device 800 can further include at least one input/output port (which can be, for example, a USB port, IEEE 1394 (FireWire) port, and/or RS-232 port) comprising physical connectors, a power supply, a satellite navigation system receiver such as a GPS receiver, a gyroscope, an accelerometer and a compass. A GPS receiver can be coupled to a GPS antenna. The device 800 can further include one or more additional antennas coupled to one or more additional receivers, transmitters and/or transceivers to enable additional functions.

It is to be understood that FIG. 8 illustrates one exemplary computing device architecture. Computing devices based on alternative architectures can be used to implement technologies described herein. For example, instead of the processors 802 and 804, and the graphics engine 852 being located on discrete integrated circuits, a computing device can comprise a SoC (system-on-a-chip) integrated circuit incorporating multiple processors, a graphics engine and additional components. Further, a computing device can connect elements via bus configurations different from that shown in FIG. 8. Moreover, the illustrated components in FIG. 8 are not required or all-inclusive, as shown components can be removed and other components added in alternative embodiments.

FIG. 9 is a block diagram of an exemplary processor core 900 to execute computer-executable instructions for implementing technologies described herein. The processor core 900 can be a core for any type of processor, such as a microprocessor, an embedded processor, a digital signal processor (DSP) or a network processor. The processor core 900 can be a single-threaded core or a multithreaded core in that it can include more than one hardware thread context (or “logical processor”) per core.

FIG. 9 also illustrates a memory 910 coupled to the processor 900. The memory 910 can be any memory described herein or any other memory known to those of skill in the art. The memory 910 can store computer-executable instruction 915 (code) executable by the processor core 900.

The processor core comprises front-end logic 920 that receives instructions from the memory 910. An instruction can be processed by one or more decoders 930. The decoder 930 can generate as its output a micro operation such as a fixed width micro operation in a predefined format, or generate other instructions, microinstructions, or control signals, which reflect the original code instruction. The front-end logic 920 further comprises register renaming logic 935 and scheduling logic 940, which generally allocate resources and queues operations corresponding to converting an instruction for execution.

The processor core 900 further comprises execution logic 950, which comprises one or more execution units (EUs) 965-1 through 965-N. Some processor core embodiments can include a number of execution units dedicated to specific functions or sets of functions. Other embodiments can include one execution unit or one execution unit that can perform a particular function. The execution logic 950 performs the operations specified by code instructions. After completion of execution of the operations specified by the code instructions, back-end logic 970 retires instructions using retirement logic 975. In some embodiments, the processor core 900 allows out of order execution but requires in-order retirement of instructions. Retirement logic 970 can take a variety of forms as known to those of skill in the art (e.g., re-order buffers or the like).

The processor core 900 is transformed during execution of instructions, at least in terms of the output generated by the decoder 930, hardware registers and tables utilized by the register renaming logic 935, and any registers (not shown) modified by the execution logic 950. Although not illustrated in FIG. 9, a processor can include other elements on an integrated chip with the processor core 900. For example, a processor can include additional elements such as memory control logic, one or more graphics engines, I/O control logic and/or one or more caches.

Any of the disclosed methods can be implemented as computer-executable instructions or a computer program product. Such instructions can cause a computer to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible computer-readable storage media, such as optical media discs (e.g., DVDs, CDs), volatile memory components (e.g., DRAM, SRAM), or non-volatile memory components (e.g., flash memory, disk drives). Computer-readable storage media can be contained in computer-readable storage devices such as solid-state drives, USB flash drives, and memory modules. Alternatively, the computer-executable instructions can be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be executed, for example, on a single computing device or in a network environment using one or more network computers. Further, it is to be understood that the disclosed technology is not limited to any specific computer language or program. For instance, the disclosed technologies can be implemented by software written in C++, Java, Perl, JavaScript. Adobe Flash, or any other suitable programming language. Likewise, the disclosed technologies are not limited to any particular computer or type of hardware. Certain details of suitable computers and hardware are known and need not be set forth in detail in this disclosure.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A. B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The disclosed methods, apparatuses and systems are not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially can in some cases be rearranged or performed concurrently. Moreover, for the sake of simplicity, the attached figures may not show the various ways in which the disclosed methods can be used in conjunction with other methods.

The following examples pertain to further embodiments.

### Example 1

A method of launching an application on a computing device, comprising: receiving a gesture via a touchscreen of the computing device, the gesture comprising a portion of an unlock gesture and an application selection gesture; and executing an application selected with the application selection gesture.

### Example 2

The method of Example 1, further comprising presenting a user interface at the touchscreen comprising a plurality of tracks along which a user can move an icon from a starting position to an end of one of the plurality of tracks, one or more applications being associated with the plurality of tracks.

### Example 3

The method of Example 2, wherein the starting position is in a first track, the unlock gesture comprises moving the icon from the starting position to an end of the first track and the application selection gesture comprises moving the icon along a second track of the plurality of tracks to a selected end of the plurality of tracks, the application selected with the application selection gesture being associated with the selected end.

### Example 4

The method of Example 2, wherein the user interface further comprises a plurality of applications icons displayed near the ends of the plurality of tracks.

### Example 5

The method of Example 1, further comprising presenting a user interface comprising a plurality of application indicators associated with a plurality of applications that can be selected with application selection gestures.

### Example 6

The method of Example 5, further comprising selecting an application indicator of the plurality of applications indicators for presentation in the user interface based on a recency of use of an application associated with the application indicator

### Example 7

The method of Example 5, further comprising selecting an application indicator of the plurality of applications indicators for presentation in the user interface based on a frequency of use of an application associated with the application indicator.

### Example 8

The method of Example 5, further comprising selecting an application indicator of the plurality of applications indicators for presentation in the user interface based on at least the location of the computing device and/or the time.

### Example 9

The method of Example 1, wherein the gesture comprises the unlock gesture, the unlock gesture being received via a touching object in contact with the touchscreen, the method further comprising in response to receiving the unlock gesture and while the touching object is still touching the touchscreen, presenting a plurality of application indicators at the touchscreen, the application selection gesture comprising selecting one of the plurality of application indicators, the executed application being an application associated with the selected application indicator.

### Example 10

The method of Example 9, wherein the application selection gesture comprises moving the touching object from an ending location of the unlock gesture on the touchscreen to a region of the touchscreen occupied by the selected application indicator.

### Example 11

One or more computer-readable storage media storing computer-executable instructions for causing a computing device to perform any one of the methods of Examples 1-10.

### Example 12

At least one computing device programmed to perform any one of the methods of Examples 1-10.

### Example 13

A method for launching an application, the method comprising: presenting a user interface at a touchscreen of a computing device, the user interface comprising a plurality of tracks along which a user can drag an icon from a starting position, one or more applications being associated with the plurality of tracks; receiving a gesture via the touchscreen, the gesture comprising moving the icon in a first direction along a first track of the plurality of tracks, and in a second direction along a second track of the plurality of tracks to an end of the second track; and executing an application associated with the second track.

### Example 14

One or more computer-readable storage media storing computer-executable instructions for causing a computing device to perform the method of Example 13.

### Example 15

At least one computing device programmed to perform the method of Example 13.

### Example 16

A method for launching application, the method comprising: receiving user input comprising a number traced on a touchscreen of a computing device while the computing device is locked; and executing an application associated with the number, the association between the application and the number being based at least in part on a usage of the application.

### Example 17

The method of Example 16, wherein the association between the application and the number is based at least in part on a recency of usage of the application and/or a frequency of use of the application.

### Example 18

The method of Example 16, the method further comprising displaying an application indicator associated with the application associated with the number.

### Example 19

One or more computer-readable storage media storing computer-executable instructions for causing a computing device to perform any one of the methods of Examples 16-18.

### Example 20

At least one computing device programmed to perform any one of the methods of Examples 16-18.

### Example 21

A method of launching an application, the method comprising: receiving first user input comprising a first number traced on a touchscreen of a computing device via a touching object; presenting a first application indicator on the touchscreen, the first application indicator being associated with a first application associated with the first number; receiving second user input comprising a second number traced on the touchscreen with the touching object; presenting a second application indicator on the touchscreen, the second application indicator being associated with a second application associated with the second number; and executing the second application; and wherein the association between the first application indicator the first number is based at least in part on a usage of the first application and the association between the second application indicator and the second number is based at least in part on the a usage of the second application.

### Example 22

One or more computer-readable storage media storing computer-executable instructions for causing a computer to perform the method of Example 21.

### Example 23

At least one computing device programmed to perform the method of claim 21.

1-23. (canceled)

24. One or more computer-readable storage media comprising a plurality of instructions that in response to being executed cause a computing device to:
receive a gesture via a touchscreen of the computing device, the gesture comprising a portion of an unlock gesture and an application selection gesture; and
execute an application selected with the application selection gesture.

25. The one or more computer-readable storage media of claim 24, further comprising a plurality of instructions that in response to being executed cause the computing device to present a user interface at the touchscreen comprising a plurality of tracks along which a user can move an icon from a starting position to an end of one of the plurality of tracks, one or more applications being associated with the plurality of tracks.

26. The one or more computer-readable storage media of claim 25, wherein the starting position is in a first track, the unlock gesture comprises moving the icon from the starting position to an end of the first track and the application selection gesture comprises moving the icon along a second track of the plurality of tracks to a selected end of the plurality of tracks, the application selected with the application selection gesture being associated with the selected end.

27. The one or more computer-readable storage media of claim 25, wherein the user interface further comprises a plurality of applications icons displayed near the ends of the plurality of tracks.

28. The one or more computer-readable storage media of claim 24, further comprising a plurality of instructions that in response to being executed cause the computing device to present a user interface comprising a plurality of application indicators associated with a plurality of applications that can be selected with application selection gestures.

29. The one or more computer-readable storage media of claim 28, further comprising a plurality of instructions that in response to being executed cause the computing device to select an application indicator of the plurality of applications indicators for presentation in the user interface based on a recency of use of an application associated with the application indicator.

30. The one or more computer-readable storage media of claim 28, further comprising a plurality of instructions that in response to being executed cause the computing device to select an application indicator of the plurality of applications indicators for presentation in the user interface based on a frequency of use of an application associated with the application indicator.

31. The one or more computer-readable storage media of claim 28, further comprising a plurality of instructions that in response to being executed cause the computing device to select an application indicator of the plurality of applications indicators for presentation in the user interface based on at least the location of the computing device and/or the time.

32. The one or more computer-readable storage media of claim 24, wherein the gesture comprises the unlock gesture, the unlock gesture being received via a touching object in contact with the touchscreen, the media further comprising a plurality of instructions that in response to being executed cause the computing device, in response to receiving the unlock gesture and while the touching object is still touching the touchscreen, to present a plurality of application indicators at the touchscreen, the application selection gesture comprising selecting one of the plurality of application indicators, the executed application being an application associated with the selected application indicator.

33. The one or more computer-readable storage media of claim 32, wherein the application selection gesture comprises moving the touching object from an ending location of the unlock gesture on the touchscreen to a region of the touchscreen occupied by the selected application indicator.

34. A computing device for launching an application, the computing device comprising:
a user interface module to receive a gesture via a touchscreen of the computing device, the gesture comprising a portion of an unlock gesture and an application selection gesture; and
a gesture interpretation module to execute an application selected with the application selection gesture.

35. The computing device of claim 34, wherein the user interface module is further to present a user interface at the touchscreen comprising a plurality of tracks along which a user can move an icon from a starting position to an end of one of the plurality of tracks, one or more applications being associated with the plurality of tracks.

36. The computing device of claim 35, wherein the starting position is in a first track, the unlock gesture comprises moving the icon from the starting position to an end of the first track and the application selection gesture comprises moving the icon along a second track of the plurality of tracks to a selected end of the plurality of tracks, the application selected with the application selection gesture being associated with the selected end.

37. The computing device of claim 35, wherein the user interface further comprises a plurality of applications icons displayed near the ends of the plurality of tracks.

38. The computing device of claim 34, wherein the user interface module is further to present a user interface comprising a plurality of application indicators associated with a plurality of applications that can be selected with application selection gestures.

39. The computing device of claim 38, further comprising an application usage module to select an application indicator of the plurality of applications indicators for presentation in the user interface based on a recency of use of an application associated with the application indicator.

40. The computing device of claim 38, further comprising an application usage module to select an application indicator of the plurality of applications indicators for presentation in the user interface based on a frequency of use of an application associated with the application indicator.

41. The computing device of claim 38, further comprising an application usage module to select an application indicator of the plurality of applications indicators for presentation in the user interface based on at least the location of the computing device and/or the time.

42. The computing device of claim 34, wherein the gesture comprises the unlock gesture, the unlock gesture being received via a touching object in contact with the touchscreen, the user interface module is further to, in response to receiving the unlock gesture and while the touching object is still touching the touchscreen, present a plurality of application indicators at the touchscreen, the application selection gesture comprising selecting one of the plurality of application indicators, the executed application being an application associated with the selected application indicator.

43. The computing device of claim 42, wherein the application selection gesture comprises moving the touching object from an ending location of the unlock gesture on the touchscreen to a region of the touchscreen occupied by the selected application indicator.

44. One or more computer-readable storage media comprising a plurality of instructions that in response to being executed cause a computing device to:
present a user interface at a touchscreen of the computing device, the user interface comprising a plurality of tracks along which a user can drag an icon from a starting position, one or more applications being associated with the plurality of tracks;
receive a gesture via the touchscreen, the gesture comprising moving the icon in a first direction along a first track of the plurality of tracks, and in a second direction along a second track of the plurality of tracks to an end of the second track; and
execute an application associated with the second track.

45. One or more computer-readable storage media comprising a plurality of instructions that in response to being executed cause a computing device to:
receive user input comprising a number traced on a touchscreen of the computing device while the computing device is locked; and
execute an application associated with the number, the association between the application and the number being based at least in part on a usage of the application.

46. The one or more computer-readable storage media of claim 45, wherein the association between the application and the number is based at least in part on a recency of usage of the application or a frequency of use of the application.
